(19) United States
(12) Patent Application Publication
(10) Pub. No.: US 2022/0186886 A1
(43) Pub. Date: Jun. 16, 2022

(54) Replaceable cartridge, cartridge system and method for connecting cartridges

(71) Applicant: Unicorn Energy GmbH, 73525 Schwäbisch Gmünd (DE)

(72) Inventors: Jörg Weigl, Schwäbisch Gmünd (DE); Felix Friederich, Schwäbisch Gmünd (DE); Johannes Dörmeorfer, Tannheimer Tal (AT)

(21) Appl. No.: 17/605,424

(22) PCT Filed: May 14, 2020
(86) PCT No.: PCT/EP2020/063437

§ 371 Date: Oct. 21, 2021

(30) Foreign Application Priority Data
May 17, 2019 (DE) 10 2019 113 063.8

(51) Int. Cl. F17C 13/08; F17C 13/04

(52) U.S. Cl. CPC F17C 13/084; F17C 13/04; F17C 2201/0109; F17C 2201/032; F17C 2201/058; F17C 2205/0126; F17C 2250/0491; F17C 2221/012; F17C 2223/0123; F17C 2250/032; F17C 2250/0439; F17C 2250/043; F17C 2205/0326

(57) ABSTRACT

A replaceable cartridge for storing a fluid includes a pressure vessel for holding the fluid; a connecting line extending from the pressure vessel to a first connection surface on an external side of the cartridge; and a valve system comprising a first shut-off member disposed in the connecting line; wherein the connecting line has a taper in a direction of the first connection surface.

### FIELD OF THE INVENTION

The present invention relates to a replaceable cartridge for storing a fluid. The invention furthermore relates to a cartridge system of at least one cartridge and a valve control unit, as well as to a method for connecting a cartridge to a further cartridge.

### BACKGROUND OF THE INVENTION

The storage of hydrogen (H2) in pressure vessels is known. Hydrogen serves as an energy carrier or accumulator and can be used wherever energy is required or available. A type of drive which utilizes hydrogen as fuel is referred to as a hydrogen drive. The hydrogen to this end is typically used as an energy carrier for a downstream drive system.

A pre-requisite for the widespread application of hydrogen drives lies in the establishment of a supply infrastructure. To this end, the energy reservoir of mobile hydrogen consumers, for example fuel cell vehicles, is to be topped up at hydrogen filling stations. However, as a result of the small number of hydrogen filling stations there has so far not been any practically usable network, on the one hand, and the filling of hydrogen in some countries requires special training with a view to safety aspects when handling pressurized reactive gases such as hydrogen, on the other hand.

The storage of hydrogen, in particular for the mobile use, is currently still problematic because the hydrogen has to be stored either in gaseous form at very high pressures (200 to 700 bar) in pressure vessels, or in liquid form at extremely low temperatures (−253° C.). This is necessary in order to store as much as possible of the gas in a justifiable space (high energy density). For storing hydrogen in small amounts, for instance in vehicles, pressure tanks up to 700 bar are exclusively used because of the light weight. Safety-relevant aspects such as the high flammability of the hydrogen or the characteristic of the latter to form an explosive gas have to also be considered in the current basic design of tanks and lines.

Proceeding herefrom, proposed according to the invention is a replaceable cartridge, a cartridge system, as well as a method for connecting a cartridge.

### SUMMARY OF THE INVENTION

Some terms are explained first.

A (storage) cartridge is a fluid reservoir for connecting to a fluid consumer. The cartridge can thus be used as a replaceable supply network component of a supply network. The cartridge can in particular be configured as part of a modular scalable fluid reservoir. The cartridge can moreover be refillable and be used in particular as a mobile hydrogen reservoir.

Fluid is understood to be a gas or a mixture of gas, or a liquid. The gas can preferably be hydrogen, oxygen, nitrogen or natural gas.

A pressure vessel is a closed vessel, the pressure of the latter in the interior being above the ambient pressure. The fluid is stored in the pressure vessel. Depending on the embodiment of the pressure vessel, the pressure in the interior can be up to 100 bar, up to 350 bar, up to 700 bar, or up to 1000 bar.

A connection surface of the cartridge is a face which is on an external side of the cartridge and which has a transport interface for transporting/transmitting the fluid to a further connector component (such as a fluid consumer, a further cartridge, a filling device, etc.).

A connecting line is understood to be a pressurized pipeline which is connected to the pressure vessel. The pressure vessel can thus be filled or emptied by way of the connecting line. The connecting line can be closed with the aid of a first shut-off member which is configured as part of a valve system. When the first shut-off member of the valve system that is disposed in the connecting line is closed, a fluid can be stored in the pressure vessel. When the first shut-off member is opened, the pressure vessel can be filled or emptied.

A shut-off member is a component which serves for stopping or releasing the volumetric flow in a pipeline. The shut-off member can shut in a unidirectional or bidirectional fashion. The shut-off member can be configured as a controllable valve, for example a magnetic valve. A magnetic valve is a valve which is activated by an electromagnet. In the event of a switched-off electromagnet, the compression spring keeps the valve closed in that said compression spring pushes the valve piston against the valve seat.

A taper is referred to as a constriction in a pressurized pipeline at which a cross-sectional area of the pressurized pipeline is reduced. This can be achieved by gradually or abruptly reducing the size of the pressurized pipeline. A shut-off member such as a valve, for example, can also represent a taper when said valve for controlling the flow of the fluid causes a reduction of the cross-sectional area down to a complete closure of the pressurized pipeline.

The handling (for example the connecting, plugging-in or removing) of a cartridge having a pressure vessel has a safety-relevant aspect because a significant amount of energy can be stored in the pressure vessel. When such a vessel is opened while pressurized, it is not only the fluid that exits but the vessel as a result of the exiting impulse of gas can be propelled in a rocket-like manner. In order for a user to be able to replace the cartridge in a safe and simple manner, a transmission of force must therefore at all times be below an established maximum value. The force indicates how intensely one body acts on another body. The pressure describes the force which acts on an area. The (pressure) force F is calculated from the product of the pressure p and the area A.

F=pA.

The invention is based on the concept that the transmission of force at a given pressure can be delimited in that the area A is kept as small as possible. The invention thus accepts an associated reduction of the flow rate (volume of the fluid per unit of time).

According to the invention, the connecting line in the direction of the first connection surface therefore has a taper.

As a result of the taper in the direction of the first connection surface that is provided in the connecting line, the cross-sectional area of the pressurized pipeline is reduced and the transmission of force is therefore at all times kept below an established maximum value. Forces which arise in the handling of the cartridge (for example when opening the pressure vessel) can thus be compensated for by a comparatively light locking mechanism.

A cross-sectional reduction along the entire connecting line is disadvantageous by virtue of a pressure loss as a result of friction on the walls and dissipation in pipelines. It is therefore additionally advantageous for the taper to be disposed in an end region of the connecting line, or so as to be directly ahead of the first connection surface in the connecting line. In an advantageous embodiment of the invention the diameter of the connecting line in the region of the taper is reduced by at least 50%, preferably 60%, furthermore preferably 80%.

According to one embodiment, the cartridge can have a through line. The through line connects the first connection surface to a second connection surface disposed on the external side of the cartridge. A second shut-off member of the valve system is disposed in the through line configured as a pressurized pipeline. When the second shut-off member is closed, the first connection surface is not fluidically connected to the second connection surface. When the second shut-off member is opened, the through line can be used as a so-called “bypass line” for transporting fluid while bypassing the pressure vessel and a fluid stored therein. The through line can be used as a bypass line, for example when a further cartridge connected to the cartridge is to be filled or emptied. Emptying/filling of a plurality of cartridges can take place in parallel or in sequence by way of the through line.

The through line can at least partially be configured as part of the connecting line. In this way, a decreasing volume of the cartridge acting on the pressurized pipelines is ideally minor, this permitting the configuration of a comparatively large pressure vessel. This moreover enables the configuration of a single transport interface on the first connection surface of the cartridge. In this embodiment, the common part of the through line and the connecting line can have the taper according to the invention.

The through line can additionally be configured as a mechanical strut or stay. The mechanical stay has a high mechanical load bearing capability as a result of which the stability of the cartridge is improved. The cartridge is thus also stable in relation to high mechanical stresses, for example in the event of an accident.

The through line can be disposed so as to be substantially within the pressure vessel. This disposal of the through line, by virtue of the lower pressure differential, permits the pressurized pipeline, and the shut-off member which is disposed therein, to be of a comparatively smaller design and dimension, this leading overall to space being saved within the cartridge. The through line is furthermore preferably configured along a central axis of the pressure vessel. In this way, the cartridge can be kept as compact as possible.

A third shut-off member of the valve system can be disposed in a common portion of the through line and the connecting line. As a result of the use of the second and the third shut-off member, wherein the second shut-off member is disposed in the through line and the third shut-off member is disposed in the common portion of the through line and the connecting line, a fluid can be selectively transmitted by one of the two connection surfaces of the cartridge and make its way to the pressure vessel. The non-common part of the through line can moreover be used as a connecting line when a second taper in the direction of the second connection surface is provided in the through line. The cartridge can thus be used in a particularly flexible manner and on both sides be coupled to connector components.

In one embodiment, the valve system can be disposed within the pressure vessel. This disposal permits a small size of all components associated with the valve assembly. The valve system comprises a first, a second and/or a third shut-off member and can be configured as one unit, for example in the form of a 3-way valve.

The cartridge can have a substantially cylindrical housing having a shell face and two end faces, wherein the first connection surface is disposed on one of the end faces. The second connection surface can be disposed on the opposite end side. In this way, the through line can run so as to be rectilinear along a central axis of the cylindrical housing. Since pressure vessels typically have a cylindrical shape, the cylindrical housing can be used as an encasement on the pressure vessel, this permitting a compact construction mode of the cartridge. The cylindrical housing can be configured as a carbon fiber casing, a glass fiber casing or from (injection-molded) plastics material. The cylindrical encasement can additionally reinforce the pressure vessel and/or protect the latter against external influences.

According to a further embodiment, the cartridge in the region of the first connection surface can have a locking element for establishing a safe connection to a fluid consumer and/or a further cartridge. Before dispensing a fluid stored in the pressure vessel to a fluid consumer (for example a fuel cell) connected to the cartridge, the replaceable cartridge should be able to be fastened to the fluid consumer in an ideally rapid and simultaneously safe manner. Various fast-release mounts for pressure vessels are known for this purpose, such as a bayonet mount, for example. The locking element is preferably configured as a permanent magnet. The permanent magnet permits the cartridge to be connected and released in a simple manner, wherein the holding force can be adjusted to the application, depending on the basic design of the permanent magnet. In this case, a mating component to be connected to the cartridge should be of a corresponding configuration and likewise have a magnetic locking element close to a connection surface. The permanent magnet is preferably configured as a ring magnet which in the region of the first connection surface extends about the transport interface. As a result of the annular symmetry, the cartridge can be connected and locked to a correspondingly configured mating component in any orientation. In an analogous manner the cartridge can have a further locking element in the region of the second connection surface. The first and/or the second connection surface can be configured as a plug or a socket, respectively, for a plug connection.

Furthermore, a transmission unit which has a communications interface connected to a communications unit can be configured in the region of the first connection surface. The cartridge can communicate with a connected fluid consumer or a connected further cartridge, and/or be controlled, by way of the communications interface connected to the communications unit. All necessary technical data and parameters can be exchanged between the cartridge and further supply network components by way of the communications interface. For example, the cartridge as a fluid reservoir in a supply network can be switched on and switched off by way of the communications interface.

The communications interface can moreover be configured as a current transmission interface for supplying the cartridge with electric power. In this way, the cartridge electrically contacts adjacent supply network components such as a connected fluid consumer or a further cartridge. All components of the cartridge, such as the valve system, for example, can be supplied with a voltage by way of the current transmission interface. The cartridge accordingly does not require any dedicated energy accumulator. The communications interface and/or the current transmission interface can be configured as wireless interfaces. The communications interface and the current transmission interface can likewise be configured so as to be rotationally symmetrical in order for the cartridge to be used in any orientation. The current transmission interface can also be configured separately from the communications interface. The cartridge can also have a transmission unit having a communications interface and/or a current transmission interface on the second connection surface.

According to one embodiment of the invention, the communications interface for the purpose of activating one or a plurality of shut-off members can be connected to the valve system. Targeted opening and closing of the individual shut-off members can thus be externally controlled by way of the communications interface. The communications unit can be configured such that the shut-off members can be opened or closed depending on the state of the cartridge (for example, the filling level) and optionally additionally received signals.

The first communications interface, configured as part of the first transmission unit, and a second communications interface, configured as part of a second transmission unit, can be connected to one another by way of the communications unit. The first and the second transmission unit can each be disposed in the region of the first and the second connection surface of the cartridge, and communications signals can thus also be transmitted beyond the cartridge.

In a further embodiment the communications unit can be connected to at least one sensor, the sensor being configured as an interior temperature sensor, an exterior temperature sensor, a pressure sensor, a gas sensor or a gas leak sensor. The connection between the sensor and the communications unit enables the sensor data to be accessed automatically or when required, said data being taken into account when controlling the valve system. The cartridge can furthermore have a filling level sensor which is connected to the communications unit, or can determine the filling level based on the values of the pressure sensor and the interior temperature sensor. The pressure sensor can be configured as a strain gauge and be disposed on the external wall of the pressure vessel. The interior temperature sensor for determining the gas temperature is preferably disposed on the pressure vessel from the outside, so as to by way of the vessel temperature draw conclusions pertaining to the gas temperature. The gas sensor can be used for determining the gas should a cartridge be used for different gases or gas mixtures.

The filling level of the cartridge can be displayed by way of a filling level display disposed on the external side of the cartridge. The filling level display can be configured as an electronic paper. A solar cell can be used for supplying the filling level display with power. A unique identification number (UIN) can be provided for easily identifying the cartridge. A GPS module can additionally be provided for locating the cartridge. The UIN and the GPS module can also be used as an anti-theft device of the cartridge. A cooling and/or heating element for adjusting a desire temperature of the fluid can furthermore be provided in the cartridge.

In one embodiment the cartridge can be configured in such a manner that the first shut-off member opens in the event of a positive pressure differential between the connecting line and the pressure vessel. A positive pressure differential is prevalent when filling the cartridge, for example. The cartridge can thus be plugged onto a filling device and the filling procedure commences in a quasi-automatic manner.

According to a further embodiment of the invention, the cartridge can be configured in such a manner that the first shut-off member automatically closes when the cartridge is mechanically separated from a fluid consumer, a filling device or a further cartridge. The cartridge is thus protected in the event of being inadvertently released, on the one hand, wherein residual fluid remains stored in the pressure vessel on account of the closed shut-off member, and on the other hand a full or half-full cartridge can be unplugged/separated at any time without having to accept any notable losses in terms of the stored fluid.

The invention furthermore relates to a cartridge system of at least one cartridge according to the invention and a valve control unit for controlling the valve system by way of the communications unit. To this end, a fluid consumer can be connected to the first connection surface of the cartridge. Furthermore, the (external) valve control unit can be configured as part of the fluid consumer. The use of an (external) valve control unit enables the shut-off members to be controlled when empty the cartridge or when using the cartridge in the bypass mode. Depending on the requirement, sequential or parallel emptying of a plurality of cartridges can take place by way of the valve control unit. The valve control unit by way of the communications unit (and the communications interface) can access arbitrary sensor data, the filling level and/or the UID of the cartridge.

The cartridge system can comprise further cartridges which are connected to the cartridge, wherein a first connection surface of the further cartridge is connected to the second connection surface of the cartridge. In one potential embodiment of the invention the cartridge system comprises a multiplicity of mutually connected cartridges. As a result of the connection between a plurality of cartridges a fluid reservoir of adjustable size can be achieved. As a result, modular tank units which can be plugged to one another and mutually separated in a simple and safe manner can be implemented even at high pressures. The capacity of such a pressure tank can be extended and scaled in an almost arbitrary manner as a result of the cartridges being plugged to one another.

The invention moreover relates to a method for connecting a cartridge according to the invention to a further cartridge according to the invention, said method comprising the following steps:
establishing a mechanical connection between a second connection surface of the cartridge and a first connection surface of the further cartridge;
establishing an electronic connection between a second transmission unit of the cartridge and a first transmission unit of the further cartridge;
establishing a connection between a first communications unit of the cartridge and a second communications unit of the further cartridge for activating the valve systems by way of the first and the second communications unit.

The establishment of a mechanical connection between the respective connection surfaces of the cartridges can take place by plugging or plugging-in, respectively (plug connection). To this end, the connection surfaces and optionally the transmission units can be configured according to the plug/socket principle. The strength of the connection can additionally be adjusted by way of one or a plurality of locking elements. An electronic connection can be established by way of a current transmission interface configured as part of the transmission units. The connection between the communications units can take place by way of the communications interfaces. The cartridges can thus be connected to one another and separated again in an arbitrary manner according to the so-called plug-and-play principle. As set forth, the use of the cartridges as fluid reservoirs is supported by hardware and software.

The method according to the invention can be continued using further features which are described in the context of the cartridge according to the invention or the cartridge system according to the invention. The cartridge according to the invention and the cartridge system according to the invention can be refined using further features which are described in the context of the method according to the invention.

Further advantages and design embodiments of the invention are derived from the description and the appended drawings.

It is understood that the features mentioned above and yet to be explained hereunder can be used not only in the respective combination stated but also in other combinations, or individually, without departing from the scope of the present invention.

The invention by means of exemplary embodiments is illustrated in a highly schematic manner and not to scale in the drawing, and will be described in detail hereunder with reference to the following drawings.

### BRIEF DESCRIPTION OF THE DRAWINGS

FIG. 1 shows a schematic view of a cartridge according to the invention;

FIGS. 2a and 2b show a schematic view of a cartridge system according to the invention having a cartridge, a further cartridge, and a fluid consumer a) prior to being plugged to one another, and b) in a state plugged to one another; and

FIGS. 3a-3c show a schematic illustration of the use of a cartridge according to the invention as a hydrogen reservoir for a bicycle in three scenarios.

### DETAILED DESCRIPTION OF THE INVENTION

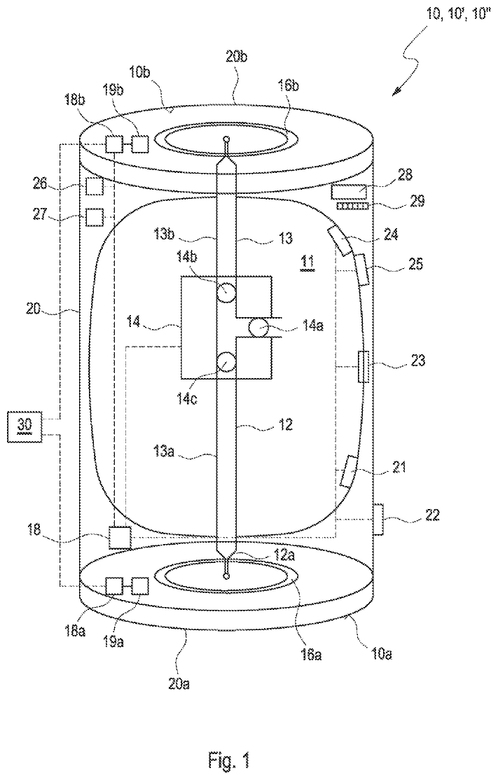

FIG. 1 shows a replaceable cartridge 10 according to the invention for storing a fluid in an advantageous embodiment. Elements of identical type of further cartridges 10′, 10″ according to the invention are provided with reference signs having corresponding index marks.

The substantially cylindrical cartridge 10 extends between a first connection surface 10a and a second connection surface 10b, and in the interior has a pressure vessel 11 for receiving a fluid. The cartridge 10 is configured in such a manner that a fluid can be received and stored in the pressure vessel 11 and dispensed again when required. The cartridge 10 is thus suitable for transporting and storing a pressurized fluid.

The cartridge 10 has a housing 20 having a substantially cylindrical housing shape having two opposite end faces. The first and the second connection surface 10a, 10b are configured on the opposite end faces. The cartridge 10 can be connected to a correspondingly configured mating component by way of the first and/or the second connection surface 10a, 10b. The correspondingly configured mating component can be a fluid consumer, one or a plurality of further cartridges 10′, 10″, a filling device or an automatic swapping device. However, one (first) connection surface 10a is already sufficient for the cartridge 10 according to the invention.

The replaceable cartridge 10 comprises a pressure vessel 11 having a substantially cylindrical shape. The pressure vessel 11 can however also have a spherical shape. The pressure vessel 11 can be composed of metal or a plastics material. The pressure vessel 11 extends across almost the entire width of the housing 20 of the cartridge 11, so as to achieve an ideally large storage volume. Depending on the intended use, the pressure vessel 11 can be conceived for different pressures. The surrounding housing 20 can be configured as a carbon fiber casing, a glass fiber casing, or from (injection-molding) plastics material, so as to protect the pressure vessel 11 against internal influences and/or additionally have the effect of a reinforcement at high pressures. The fluid to be stored can be a gas such as, for example, hydrogen, oxygen, nitrogen or natural gas, or a gas mixture or a liquid.

The pressure vessel 11 of the cartridge 10 in the embodiment shown is filled with hydrogen. The cartridge can thus be used as a (refillable) hydrogen reservoir for connecting to a fuel cell as a fluid consumer. The pressure vessel 11 for the use as a hydrogen reservoir is conceived for pressures of up to 700 bar.

Proceeding from the pressure vessel 11, a connecting line extends to a first connection surface 10a on an external side of the cartridge 10. The pressure vessel 11, by way of the connecting line 12 configured as a pressurized pipeline, is fluidically connected to a mating component connected to the connection surface 10a. A fluid can be transported from or to the pressure vessel 11 by way of the connecting line 12. A first shut-off member 14a as part of a valve system 14 is disposed in the connecting line 12. The first shut-off member 14a in this exemplary embodiment is configured as a magnetic valve and is controlled by an electromagnet (not illustrated). When the first shut-off member 14a is opened, the pressure vessel 11 can be filled or emptied by way of the connecting line 12. When the first shut-off member 14a is closed, a fluid can be stored in the pressure vessel 11.

In order to guarantee that a user can safely use the cartridge 10, for example connect the cartridge 10 to a mating component or remove said cartridge 10 from the latter, the transmission of force in the use of the cartridge 10 (such as filling or emptying the pressure vessel 11, respectively) must stay below an established maximum value. To this end, the cross-sectional area of the connecting line is correspondingly reduced according to the invention. To this end, the connecting line 12 has a taper 12a. Depending on the established maximum value for the transmission of force, a diameter of the connecting line in the region of the taper is reduced/tapered by more than 80%. The taper 12a can be disposed at any location in the connecting line 12, but it is advantageous for the taper 12a to be disposed directly ahead of the end of the connecting line 12, so as to be close to the first connection surface 10a, in order to prevent losses within the pressurized pipeline. The taper according to the invention guarantees that a user can safely handle the cartridge 10 at any time.

The cartridge 10 is furthermore configured in such a manner that the first shut-off member 14a in the event of a positive pressure differential between the connecting line 12 and the pressure vessel 11 opens automatically. In this way, the cartridge 10 can be filled in a rapid and simple manner.

The cartridge 10 moreover has a through line 13. The through line 13, likewise configured as a pressurized pipeline, extends from the first connection surface 10a to the second connection surface 10b. The through line 13 in this embodiment has a common first portion 13a with the connecting line 12, and is configured as a mechanical stay, both however not being mandatory. In this first portion 13a of the through line 13 the latter is configured as part of the connecting line 12, and in a second portion 13b the through line 13 establishes a connection between the connecting line 12 and the second connection surface 10b. The through line 13, for the same reason as the connecting line 12, in each of the first and the second portion 13a, 13b has a taper.

A second shut-off member 14b, configured as part of the valve system 14, is disposed in the through line 13. The second shut-off member 14b is disposed in the second portion 13b of the through line and permits the through line 13 to be closed. In the event of a closed second shut-off member 14b the cartridge can be used as described above. In the event of an opened second shut-off member 14b and closed first shut-off member 14a the through line 13 can be used as a bypass line for transporting fluid while bypassing the pressure vessel 11.

The through line 13 can furthermore have a third shut-off member 14c, configured as part of the valve system 14. The third shut-off member 14c is disposed in the common portion 13a of the through line and connecting line 12, 13. In the event of a closed position of the third shut-off member 14c and simultaneously opened first and second shut-off member 14a, 14b, the second portion 13b of the through line 13 can be used as a connecting line, so to speak, and the cartridge 10 can also be filled or emptied by way of a transport interface of the second connection surface 10b.

The first, the second and the third shut-off member 14a, 14b, 14c are part of the valve system 14 which is connected to the one communications unit 18 and can be controlled by the latter. The individual shut-off members 14a, 14b, 14c can be activated individually or in combination by the communications unit 18. To this end, the communications unit 18 is connected to an external valve control unit 30. The connection between the valve control unit 30 and the communications unit 18 can also take place by way of a communications interface 18a, 18b which is explained hereunder. The valve control unit 30 is preferably configured as an external component, for example as part of a fluid consumer which is connected to the cartridge 10.

In the embodiment shown, the cartridge 10 has a first transmission unit 20a, disposed in the region of the first connection surface 10a, and a second transmission unit 20b, disposed in the region of the second connection surface 10b. However, one (first) transmission unit 20a is already sufficient for the use of the cartridge 10 according to the invention. The first and the second transmission unit 20a, 20b each extend about (a) transport interface(s) configured at the end of the connecting line 12 and optionally at the ends of the through line 13, the fluid being able to be transported by way of said transport interface(s). The connection surfaces 10a, 10b including the transmission units 20a, 20b can be configured according to the plug/socket principle. The cartridge 10 can thus be easily plugged to a correspondingly configured mating component.

By way of the transmission unit 20a, 20b it can be ensured that a transmission of the fluid takes place only once a connected mating component is certified so as to be compatible. The transmission unit 20a in this exemplary embodiment to this end has a communications interface 18a which is connected to the communications unit 18. The communications interface 18a serves for the communication of the cartridge 10′ of a connected identically configured mating component such as a further cartridge 10′, 10″ or a fluid consumer. The transmission unit 20a in this embodiment moreover has a current transmission interface 19a. The current transmission interface 19a serves for supplying the electrical components of the cartridge 10 with electric power. The communications interface 18a and the current transmission interface 19a can also be configured as a common interface. The communications and/or current transmission interface 18a, 19a can also be configured so as to be wireless. In the embodiment of the cartridge 10 shown, the communications unit 18 is additionally connected to a second communications interface 18b which is disposed in the second transmission unit 20b and is likewise configured as a current transmission interface 19b.

In order to prevent the cartridge 10 from being unintentionally released from a connected mating component, the cartridge 10 in the region of the connection surfaces 10a, 10b additionally has in each case one locking element 16a, 16b. In the embodiment shown, the locking elements 16a, 16b are configured as annular permanent magnets which extend about the transport interface. The cartridge by means of the permanent magnet can be safely attached to a correspondingly configured mating component and be removed from the latter again in a simple manner. By virtue of the annular configuration of the permanent magnet the locking action can be performed at any orientation of the cartridge 10.

As has already been discussed, the controlling of the valve system 14 is performed by way of the communications unit 18 of the cartridge 10. For this purpose, the communications unit 18 can be additionally connected to various sensors of the cartridge 10. In the embodiment shown, the cartridge 10 has an interior temperature sensor 21, an exterior temperature sensor 22, a pressure sensor 23, a gas sensor 24 and a gas leak sensor 25. The communications unit 18 can perform the controlling of the valve system 14 based on the received measuring data of the sensors. The sensor data, proceeding from the communications unit 18, can also be transmitted beyond the communications interfaces 18a, 18b.

The interior temperature sensor 21 serves for determining the gas temperature in the interior of the gas pressure vessel 11. The interior temperature sensor is however preferably attached to the metallic pressure vessel 11 from the outside, so as to draw conclusions pertaining to the gas temperature by way of the vessel temperature. The exterior temperature sensor 22 can be evaluated in combination with the interior temperature sensor 21 so as to gain conclusions pertaining to a potential increase in the gas temperature. The pressure sensor 23 can be configured as a strain gauge on the external wall of the pressure vessel 11. The combination of the pressure sensor 23 and the interior temperature sensor 21 permits the filling level of the pressure vessel 11 to be detected. The gas sensor 24 can be utilized for determining the fluid. This is expedient when the same cartridge 11 is used for different fluids. A warning in the event of a leak or a malfunction of the cartridge 10 can take place by way of the gas leak sensor 25.

The illustrated cartridge 10 on the external side moreover has a filling level display 28. This display device is configured in the form of an ink paper display and possesses a dedicated power supply in the form of a solar cell 29. Alternatively, the filling level display 28 can also be connected to a current supply interface 19a, 19b. As a further display device, the cartridge 10 can have an operating state display (not illustrated) in the form of a multi-colored light emitting diode. It can thus be immediately seen from the outside whether the cartridge 10 is currently being filled or emptied, for example.

The illustrated cartridge 10 moreover has a heating element 26 and a cooling element 27. Depending on the envisaged use of the cartridge 10, a stored fluid can be adjusted to a predetermined temperature with the aid of the heating or cooling element 26, 27. In the use of the cartridge 10 as an oxygen reservoir, for example, the oxygen prior to an application as a respiratory gas can be brought to a temperature close to the ambient temperature or the body temperature.

The cartridge 10 can furthermore have an identification unit (not illustrated) which permits the cartridge 10 to be unequivocally identified. This here can be a unique identification number (UIN), for example.

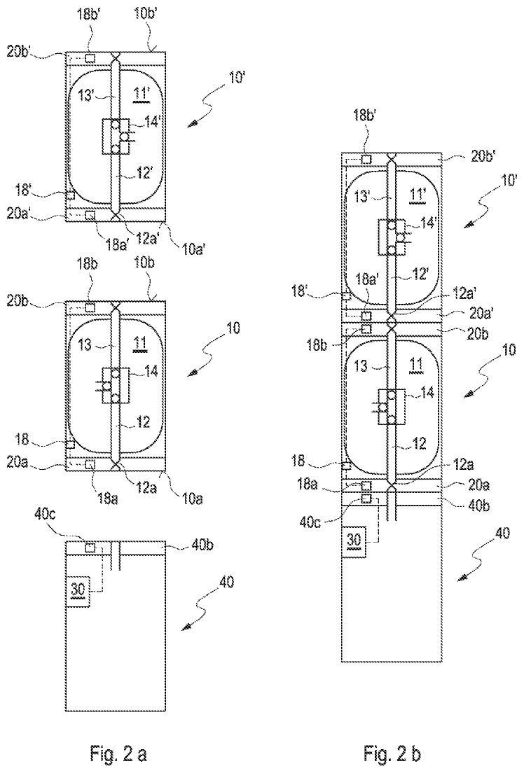

FIGS. 2a and 2b show a cartridge system according to the invention composed of a cartridge 10, a further cartridge 10′, and a fluid consumer 40. The fluid consumer 40 in the exemplary embodiment illustrated is a fuel cell. The cartridges 10, 10′ are in each case configured according to the cartridge 10 shown in FIG. 1 but are illustrated in a highly simplified manner. The cartridge system is shown prior to being plugged together in FIG. 2a. The cartridge system plugged together is shown in FIG. 2b.

The fluid consumer 40, disposed at the bottom in FIG. 2, has a transmission unit 40b which is configured in a manner compatible to that of the transmission unit 20b described above. Therefore, the cartridge 10 by way of the transmission unit 20a, configured in the region of the first connection surface 10a, can thus be plugged into the transmission unit 40b of the fluid consumer 40 according to the plug/socket principle. The connecting line 12 of the plugged-in cartridge 10 in this instance is fluidically connected to a pressurized pipeline of the fluid consumer 40, and a fluid can be transmitted between the cartridge 10 and the fluid consumer 40.

According to the same principle, a further cartridge 10′, which in the region of the first connection surface 10a′ has a first transmission unit 20a′, can be plugged onto a transmission unit 20b of the cartridge 10 that is configured in the region of the second connection surface 10b. The further cartridge 10′ by way of the connecting line 12′ thereof is fluidically connected to the through line 13 of the cartridge 10 and by way of the latter also to the fluid consumer 40. Further cartridges 10″ can be plugged on according to the same principle, said further cartridges 10″ conjointly forming a scalable tank.

The fluid consumer 40 furthermore has a valve control unit 30 for controlling the valve systems 14 and 14′. The transmission unit 40b of the fluid consumer 40 has a communications interface 40c which is connected to the valve control unit 30 (dashed line in FIG. 2). In the cartridge system illustrated in FIG. 2, all communications interfaces 40c, 18a, 18b, 18a′, 18b′ are also configured as current transmission interfaces.

When the cartridge 10′ is connected to the fluid consumer 40, the communications interface 40c is in contact with a first communications interface 18a of the cartridge 10′. The first communications interface 18a, by way of a communications unit 18, in turn is in contact with a second communications interface 18b of the cartridge 10 (dashed line). The communications unit 18 of the cartridge 10 is thus in contact with the valve control unit 30. According to the same principle, a communications unit 18′ of the further cartridge is also in contact with the communications unit 18 of the cartridge 10 and the valve control unit 30.

Sequential or parallel emptying of the cartridges 10, 10′ can thus be controlled by way of the valve control unit 30. The pressure vessel 11′ of the further cartridge 10′, by means of the through line 13 can be used for transporting a fluid while bypassing the pressure vessel 11 or in parallel to the latter. A further cartridge 10′, which is connected to the second connection surface 10b of the cartridge 10, by way of the through line 13 of the cartridge 10 can dispense a fluid to a fluid consumer 40 which is connected to the first connection surface 10a of the cartridge 10.

The individual components of the plugged-together cartridge system can be mutually separated at any time by overcoming the holding force of the locking elements (not illustrated). The communications units 18, 18′ are configured such that the first shut-off members 14a, 14a′ of the valve systems 14, 14′ automatically close in this event and fluid can no longer exit from the pressure vessels 11, 11′.

The method for connecting the cartridge 10 and the further cartridge 10′ thus takes place by first establishing a mechanical connection between the second connection surface 10b and the first connection surface 10a in the form of a plug-connection between the cartridges 10, 10′. Once the cartridges 10, 10′ are mechanically connected to one another, said cartridges 10, 10′ are fluidically connected. An electronic connection between the second transmission unit 20b and the first transmission unit 20a′ is simultaneously established, wherein the electronic connection is performed between the communications interfaces 18b and 18a′ configured as current transmission interfaces. In this embodiment of the cartridges 10, 10′, the connection between the communications units 18, 18′ of the cartridges 10, 10′ is likewise simultaneously established by way of the communications interfaces 18b, 18af. The valve systems 14, 14′ of the cartridges 10, 10′ can be activated by way of the communications units 18, 18′.

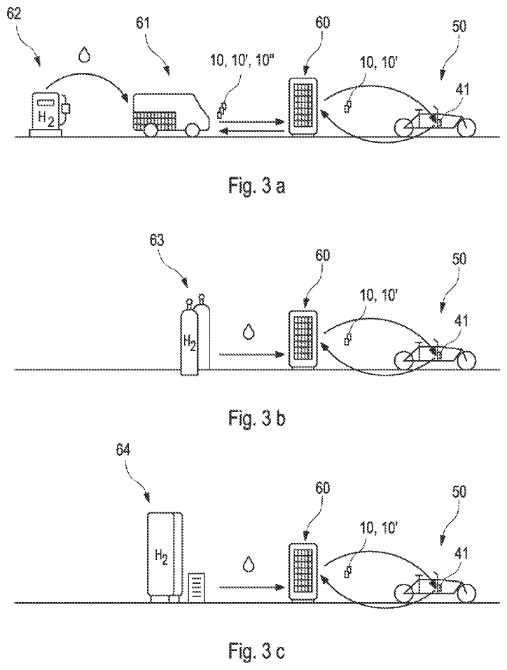

FIG. 3 shows the use of a cartridge 10, 10′, 10″ according to the invention as a refillable hydrogen reservoir (H2 reservoir) for a (load-carrying) bicycle 50 in three different scenarios.

Bicycles with electronic pedaling assistance are known, but a complete charging procedure at a mains plug in most instances takes several hours. For this reason, bicycles 70 which by way of a fuel cell 41 (as the fluid consumer) produce the current for the electric motor on-board are particularly advantageous. To this end, the fuel cell 41 accommodated on the bicycle 70 has to be supplied with hydrogen in tanks. To this end, one or a plurality of cartridges 10, 10′, 10″ according to the invention, filled with hydrogen, can be plugged onto the fuel cell 41 of the bicycle 70 in a simple and safe manner, said fuel cell 41 being designed according to the invention, and once the hydrogen has been consumed be removed again in a likewise simple and safe manner. The number of required cartridges 10, 10′ depends inter alia on the distance which is to be travelled by the bicycle 70.

In each of the scenarios shown in FIGS. 3a-3c the supply of hydrogen to the bicycle 70 using the replaceable cartridges 10, 10′ takes place by way of an automatic swapping device 60. The automatic swapping device 60 can be, for example, a filling station or a kiosk. Cartridges 10, 10′, 10″ filled with hydrogen are kept available in sufficient numbers in the automatic swapping device 60. A (registered) user can retrieve the cartridges 10, 10′ in the required numbers from the automatic swapping device 60 as required, or exchange said cartridges 10, 10′ for empty cartridges 10, 10′, respectively. As opposed to a hydrogen filling station 62, automatic swapping devices 60 have the advantage that the latter can be set up in a flexible manner as required, almost at any locations and with the required capacity (independently of the hydrogen filling station or any other hydrogen infrastructure). The cartridge 10, 10′ according to the invention can be replaced by a user himself/herself in a simple and safe manner. The replacement of an empty cartridge 10, 10′ by a full cartridge 10, 10′ on a bicycle 70 thus takes place by a user within a few seconds.

To this end, the automatic swapping device 60, or the cartridges 10, 10′ kept available therein, have to be regularly supplied with hydrogen (H2) or be filled with new or refilled cartridges.

In a first scenario (a) the delivery of the new or refilled cartridges 10, 10′, 10″, respectively, and the collection of the empty cartridges 10, 10′, 10″ takes place by means of a transport vehicle 61 which transports the cartridges 10, 10′, 10″ back and forth between a hydrogen filling station 62 and the automatic swapping device 60. The cartridges 10, 10′, 10″ can be refilled in a simple and rapid manner at the hydrogen filling station 63, and from there be distributed to different automatic swapping devices 60 as required.

According to a second scenario (b) the hydrogen supply takes place with the aid of external hydrogen bottles 63 which are brought to the automatic swapping device 60. The hydrogen bottles 63 can either be connected directly to the automatic swapping device 60 and thus serve for filling all cartridges 10, 10′ that are disposed in the automatic swapping device (and are not already fully filled), or the individual cartridges 10, 10′ are individually connected to the hydrogen bottle 63 as the filling device on site and then (re-)filled.

According to a third scenario (c) the hydrogen supply takes place with the aid of a dedicated hydrogen production device 64 which is set up so as to be physically close to the automatic swapping device 60. This is particularly preferable when the automatic swapping device 60 has a high and regular turnover of hydrogen. The dedicated hydrogen production device 64 according to scenario (b) can likewise be connected directly to the automatic swapping device 60, or for filling be in each case connected to the individual cartridges 10, 10′.

All three scenarios have the advantage that returned cartridges which have not been completely emptied can be topped up or filled again without residual hydrogen still in the cartridge being lost. Moreover, cartridges 10, 10′ of different sizes can be kept available in the automatic swapping device 60.

The invention is thus said to provide a system of cartridges for the pressurized storage of fluid, said cartridges being able to be replaced in a safe and simple manner.

1-15. (canceled)

16. A replaceable cartridge for storing a fluid, comprising:
a pressure vessel for holding the fluid;
a connecting line extending from the pressure vessel to a first connection surface on an external side of the cartridge; and
a valve system comprising a first shut-off member disposed in the connecting line;
wherein the connecting line has a taper in a direction of the first connection surface.

17. The cartridge according to claim 16, and further comprising a through line connecting the first connection surface to a second connection surface disposed on the external side of the cartridge, wherein a second shut-off member of the valve system is disposed in the through line.

18. The cartridge (10) according to claim 17, wherein the through line is formed as a mechanical strut or is arranged substantially within the pressure vessel.

19. The cartridge according to claim 17, wherein a third shut-off member of the valve system is disposed in a common part of the through line and the connecting line.

20. The cartridge according to claim 16, wherein the valve system is disposed in an interior of the pressure vessel.

21. The cartridge according to claim 16, wherein the cartridge has a substantially cylindrical housing having a shell surface and two end faces, wherein the first connection surface is disposed on one of the end faces.

22. The cartridge according to claim 16, wherein a locking element for establishing a safe connection to a fluid consumer or a further cartridge is disposed in a region of the first connection surface.

23. The cartridge according to claim 16, wherein a transmission unit is configured in a region of the first connection surface, the transmission unit having a communications interface or a current transmission interface connected to a communications unit, the communications interface preferably being configured as a current transmission interface.

24. The cartridge according to claim 23, wherein the communications unit is connected to the valve system for activating one or a plurality of shut-off members.

25. The cartridge according to claim 23, wherein a first communications interface, configured as part of a first transmission unit, is connected to a second communications interface configured as part of a second transmission unit through the communications unit.

26. The cartridge according to claim 23, wherein the communications unit is connected to at least one sensor, the at least one sensor preferably being configured as an interior temperature sensor, an exterior temperature sensor, a pressure sensor, a gas sensor or a gas leak sensor.

27. The cartridge according to claim 16, wherein the cartridge is configured in such a manner that the first shut-off member opens in the event of a positive pressure differential between the connecting line and the pressure vessel, or wherein the cartridge is configured in such a manner that the first shut-off member closes when being mechanically separated from a fluid consumer or a further cartridge.

28. A cartridge system of at least one cartridge configured according to claim 16, and a valve control unit for controlling the valve system by way of a communications unit, wherein a fluid consumer is connected to the first connection surface of the cartridge.

29. The cartridge system according to claim 27, and including a further cartridge which is connected to the cartridge, wherein a first connection surface of the further cartridge is connected to the second connection surface of the cartridge.

30. The cartridge system as in claim 17, wherein the through line is at least partially formed as part of the connecting line.

31. The cartridge system as in claim 18, wherein the through line is arranged along a central axis of the pressure vessel.

32. The cartridge system as in claim 22, wherein the locking element is configured as a permanent magnet.

33. The cartridge system as in claim 28, wherein the valve control unit is configured as part of the fluid consumer.

34. A method for connecting a cartridge to a further cartridge, each being configured according to claim 24, the method comprising the following steps:
establishing a mechanical connection between a second connection surface of the cartridge and a first connection surface of the further cartridge;
establishing an electronic connection between a second transmission unit of the cartridge and a first transmission unit of the further cartridge;
establishing a connection between a first communications unit of the cartridge and a second communications unit of the further cartridge for activating a valve system by way of the first and the second communications unit.
